(19) United States
(12) Patent Application Publication
(10) Pub. No.: US 2015/0358180 A1
(43) Pub. Date: Dec. 10, 2015

(54) NETWORK DEVICE

(71) Applicant: NEC CORPORATION, Minato-ku, Tokyo (JP)

(72) Inventors: Kazunori KAMACHI, Tokyo (JP); Atsushi KIKUCHI, Tokyo (JP); Tomoaki SATO, Tokyo (JP)

(73) Assignee: NEC Corporation,, Minato-ku, Tokyo (JP)

(21) Appl. No.: 14/655,385

(22) PCT Filed: Nov. 6, 2013
(86) PCT No.: PCT/JP2013/006537

§ 371 Date: Jun. 25, 2015

(30) Foreign Application Priority Data
Dec. 26, 2012 (JP) 2012-282426

(51) Int. Cl. H04L 12/46; H04L 12/705

(52) U.S. Cl. CPC H04L 12/4641; H04L 45/18

(57) ABSTRACT

This network device (300) comprises: a plurality of ports (310) which are respectively associated with a preset virtual network and a domain which configures a network on a group unit basis which differs from the virtual network; a loop detection frame transmission means (321) for transmitting a loop detection frame from the port to another device on the network; a loop detection frame receiving means (322) for receiving the loop detection frame via the port from the other device on the network; and a loop detection means (323) for detecting that a loop has occurred, on the basis of the received loop detection frame, when the transmission source of the loop detection frame is the present device, and the receiving port and the transmission source port are associated with the same domain.

### TECHNICAL FIELD

The present invention relates to a network device and in particular relates to a network device having a function for detecting a network loop.

### BACKGROUND ART

When performing loop detection in a network, there are methods such as physical port loop detection and VLAN (Virtual Local Area Network) port loop detection. For example, an example of a VLAN port loop detection is disclosed in PTL (Patent Literature) 1.

In the physical port loop detection described above, a method is used in which, when a loop detection frame is transmitted from a specific port or all physical ports of the local device and the loop detection frame transmitted from the local device is received via a physical port of the local device, it is determined and detected as a loop. Therefore, a problem arises in which loop detection cannot be performed in a virtual network (VLAN unit). This is because, in a VLAN (802.1q), a plurality of virtual networks can be built within the same physical port. In other words, it is not possible to specify a VLAN having a loop since all VLANs within the same physical port are loop targets because detection is performed on a physical port unit basis in the physical port loop detection method.

Additionally, in the VLAN port loop detection described above, when a loop detection frame is transmitted from a port with which a specific VLAN, that is, VLAN ID of the local device is associated and the loop detection frame transmitted from the local device is received via a port with which the same VLAN ID of the local device is associated, it is determined and detected as a loop. Thereby, loop detection in a virtual network (VLAN unit) is made possible.

### CITATION LIST

### Patent Literature

[PTL 1] Japanese Laid-open Patent Publication No. 2008-67306

### SUMMARY OF INVENTION

### Technical Problem

However, there are the following problems when loop detection is performed in a network of a “domain unit” using the VLAN port loop detection described above. Note that a network of a “domain unit” refers to a network configuration of group units which enables interconnections in which a VLAN connection within a respective network, such as a port base VLAN, a tag base VLAN, PB (IEEE802.1ad), PBB (IEEE802.1ah) and the like, is defined by the same logical port.

The first problem is that, although, in a network of a domain unit, ports which are associated with different domains even in the same VLAN ID are determined as being in different networks, it results in being determined as loop detection when VLAN IDs are the same in a method of the VLAN port loop detection. The second problem is that, although, in a network of a domain unit, ports associated with the same domain even in different VLAN IDs are determined as being in the same network, it is not determined as a loop for different VLAN IDs in the method of the VLAN port loop detection. Thus, a problem arises in which it is not possible to properly detect a loop in a network of a domain unit.

Accordingly, an object of the present invention is to provide a network device capable of solving the problems described above in which it is not possible to properly detect a loop in a network of a domain unit.

### Solution to Problem

A network device which is an embodiment of the present invention forms a configuration which

includes a plurality of ports each associated with a preset virtual network and a domain which constitutes a network of group units different from the virtual network

and further includes:

loop detection frame transmission means for transmitting a loop detection frame to other device on a network from the ports;

loop detection frame receiving means for receiving the loop detection frame from other device on a network via the ports; and

loop detection means for detecting a loop occurrence when, based on the loop detection frame received by the loop detection frame receiving means, a transmission source of the loop detection frame is the local device, and a port via which the loop detection frame has been received and a port of the transmission source of the loop detection frame are associated with the same domain.

A network system which is another embodiment of the present invention forms a configuration which includes a plurality of network devices, each of which includes

a plurality of ports which are respectively associated with a preset virtual network and a domain which constitutes a network of group units different from the virtual network

and further includes:

loop detection frame transmission means for transmitting a loop detection frame to other device on a network from the ports;

loop detection frame receiving means for receiving the loop detection frame from other device on a network via the ports; and

loop detection means for detecting a loop occurrence when, based on the loop detection frame received by the loop detection frame receiving means, a transmission source of the loop detection frame is the local device and a port via which the loop detection frame has been received and a port of the transmission source of the loop detection frame are associated with the same domain,

wherein, the plurality of network devices include: a first network device for transmitting the loop detection frame to other network device; and a second network device for receiving the loop detection frame,

in the second network device, when the loop detection means has determined that the transmission source of the loop detection frame received by the loop detection frame receiving means is not the local device, the loop detection frame transmission means transfers the loop detection frame, based on the received loop detection frame, to a port which is a port provided on other device in a network, the port being associated with the same domain as the domain with which the port which becomes a transmission source of the loop detection frame is associated, from a port provided on the local device associated with the same domain.

A program which is another embodiment of the present invention is a program causing a network device including a plurality of ports which are respectively associated with a preset virtual network and a domain which constitutes a network of group units different from the virtual network to implement:

loop detection frame transmission means for transmitting a loop detection frame to other device on a network from the ports;

loop detection frame receiving means for receiving the loop detection frame from other device on a network via the ports; and

loop detection means for detecting a loop occurrence when, based on the loop detection frame received by the loop detection frame receiving means, a transmission source of the loop detection frame is the local device and a port via which the loop detection frame has been received and a port of the transmission source of the loop detection frame are associated with the same domain.

A loop detection method which is another embodiment of the present invention has a configuration in which,

a network device including a plurality of ports each associated with a preset virtual network and a domain which constitutes a network of group units different from the virtual network

transmits a loop detection frame to other device on a network from the ports,

receives the loop detection frame from other device on a network via the ports, and

detects a loop occurrence when, based on the received loop detection frame, a transmission source of the loop detection frame is the local device and a port via which the loop detection frame has been received and a port of the transmission source of the loop detection frame are associated with the same domain.

### Advantageous Effects of Invention

The present invention can properly detect a loop in a network of domain units by forming the configurations described above.

### BRIEF DESCRIPTION OF DRAWINGS

FIG. 1 is a diagram for describing loop detection in a network of domain units according to the present invention.

FIG. 2 is a diagram illustrating a domain management table in the network device disclosed in FIG. 1.

FIG. 3 is a block diagram illustrating a configuration of a network device according to an exemplary embodiment 1 of the present invention.

FIG. 4 is a diagram illustrating an example of a data structure of a loop detection frame which is transmitted and received in the network device disclosed in FIG. 3.

FIG. 5 is a diagram illustrating a specific example of the data structure of the loop detection frame disclosed in FIG. 4.

FIG. 6 is a flowchart illustrating operation when the network device disclosed in FIG. 3 transmits a loop detection frame.

FIG. 7 is a flowchart illustrating operation when the network device disclosed in FIG. 3 receives a loop detection frame.

FIG. 8 is a diagram illustrating a configuration of a network system and a flow of a loop detection frame according to an exemplary embodiment 2 of the present invention.

FIG. 9 is a block diagram illustrating a configuration of a network device according to a supplementary note 1 of the present invention.

### DESCRIPTION OF EMBODIMENTS

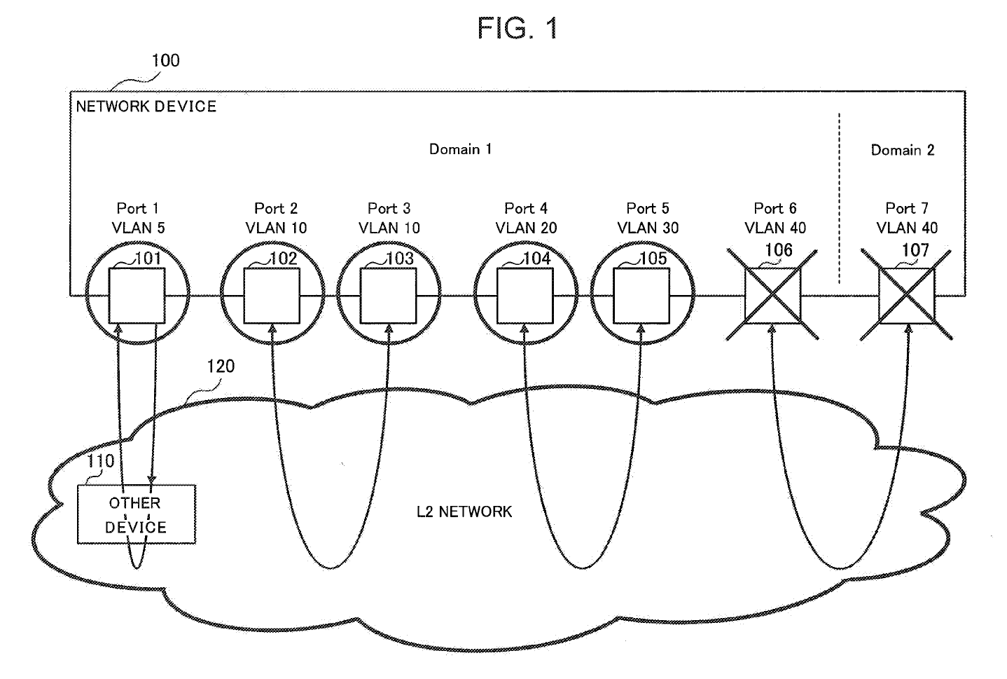

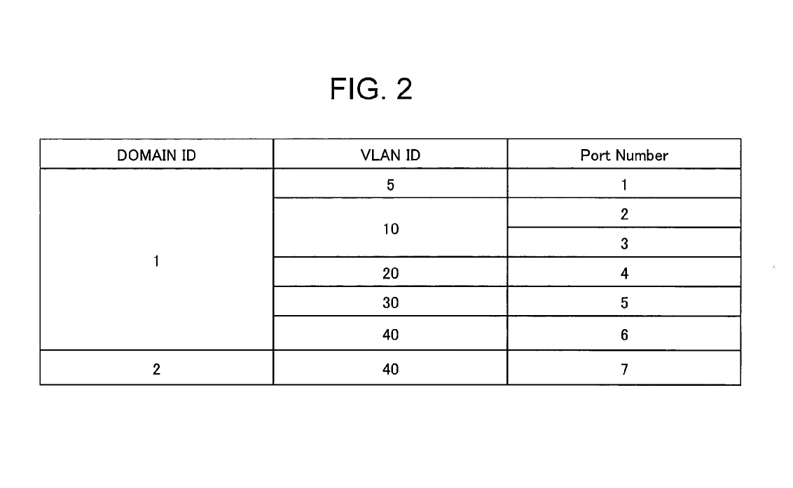

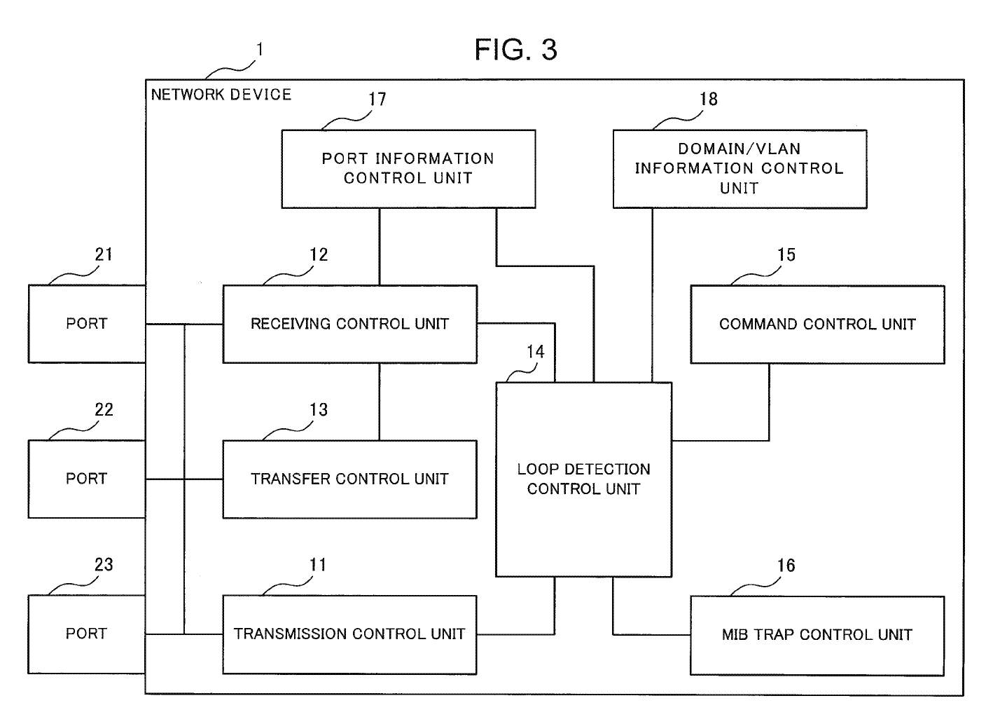

A first exemplary embodiment of the present invention will be described with reference to FIG. 1 to FIG. 7. First, an example of loop detection by a network device according to the present invention will be described with reference to FIG. 1 to FIG. 2. In addition, a configuration and operation of the network device according to the present invention will be described with reference to FIG. 3 to FIG. 7.

A network device 100 illustrated in FIG. 1 is network equipment such as a switch device connected to an L2 network 120 which is a network system and includes a plurality of ports 101 to 107 for transmitting and receiving data. Each port is associated with a predetermined virtual network (VLAN) and a domain which constitutes a network of group units different from the virtual network. The “domain” refers to a network configuration of group units which enables interconnections in which a VLAN connection within a respective network, such as a port base VLAN, a tag base VLAN, PB (IEEE802.1ad), PBB (IEEE802.1ah) and the like, is defined by the same logical port.

Each of the ports 101 to 107 in an example of FIG. 1 is associated with a VLAN and a domain as illustrated in a domain management table of FIG. 2. Specifically, ports indicated by Port 1 (101) to Port 6 (106) are associated with a Domain 1 domain and a port indicated by Port 7 (107) is associated with a Domain 2 domain. Furthermore, in Domain 1, Port 2 (102) and Port 3 (103) are associated with the same VLAN (VLAN ID=10) but Port 1 (101), Port 4 (104), Port 5 (105), and Port 6 (106) are associated with different VLANs (VLAN ID=5, 20, 30, 40 respectively). In addition, Port 6 (106) and Port 7 (107) are associated with different domains but are associated with the same VLAN (VLAN ID=40) as described above.

The network device 100 according to the present invention which includes the ports described above performs loop detection as follows. Note that, in FIG. 1, a flow of a loop detection frame is indicated by an arrow and a ∘ (circle) mark represents that it is determined as loop detection and a × (cross) mark represents that it is determined as no loop detection.

First, it is assumed that the network device 100 has transmitted a loop detection frame from Port 1 (101). In this case, when the network device 100 has subsequently received the loop detection frame via Port 1 (101) which is a transmission source port of the network device 100 which is the local device through other device 110 in the L2 network 120, it is determined as loop detection.

Furthermore, it is assumed the network device 100 has transmitted loop detection frames from Port 2 (102) and Port 3 (103) which are ports associated with Domain 1 which is the same domain and VLAN ID=10 which is the same VLAN. In this case, when the loop detection frames have been subsequently received via Port 2 (102) and Port 3 (103) of the network device 100 through a network of the L2 network 120, it is also determined as loop detection.

In addition, it is assumed the network device 100 has transmitted loop detection frames from Port 4 (104) and Port 5 (105) which are ports associated with Domain 1 which is the same domain and VLAN IDs=20 and 30 which are different VLANs. In this case, when the loop detection frames have been subsequently received via Port 4 (104) and Port 5 (105) of the network device 100 through a network of the L2 network 120, it is also determined as loop detection.

On the other hand, it is assumed that loop detection frames have been transmitted from Port 6 (106) and Port 7 (107) which are ports associated with the same VLAN which is VLAN ID=40 and different domains which are Domains 1 and 2. In this case, even when the loop detection has been subsequently received via Port 6 (107) and Port 7 (107) of the network device 100 through a network of the L2 network 120, it is not determined as loop detection.

As described above, the network device 100 of the present invention transmits a loop detection frame per domain from the local device and performs determination of domain attributes of a port of a transmission source of the loop detection frame transmitted by the local device and a port via which the frame has been received. When the attributes of the port of the transmission source of the received loop detection frame and the port via which the frame has been received are the same domain, it is determined that a frame loops back in the same network even though VLAN IDs are different, which makes a loop detection possible. On the other hand, when the attributes of the port of the transmission source of the loop detection frame and the port via which the frame has been received are the same VLAN ID but different domains, it is determined that the frames are transmitted in different networks and it is possible not to determine as a loop.

Hereinafter, configurations and operation of a network device are further described in more detail with reference to FIG. 3 to FIG. 7. As illustrated in FIG. 3, a network device 1 includes a plurality of ports 21 to 23 and further includes a transmission control unit 11, a receiving control unit 12, a transfer control unit 13, a loop detection control unit 14, a command control unit 15, an MIB trap control unit 16, a port information control unit 17, and a domain/VLAN information control unit 18. Note that each of these control units 11 to 18 is built by incorporating a program in an operation device provided in the network device 1.

Each of the ports 21 to 23 described above is assigned with a port number and is managed by the port information control unit 17 described above. In other words, the port information control unit 17 stores in advance port information including a port number and the like of each of the ports 21 to 23 in a storage device provided in the network device 1 to manage. Note that the port information control unit 17 notifies port information of a port which becomes a transmission source in response to a request from the loop detection control unit 14 at a time of generation of a loop detection frame as described later.

Furthermore, each of the ports 21 to 23 is associated with a domain and a VLAN as described above, and information of the domain and the VLAN with which each of the ports is associated is managed by the domain/VLAN information control unit 18. In other words, the domain/VLAN information control unit 18 stores in advance, in a storage device provided in the network device 1, a domain number (domain identification information) for identifying a domain with which each of the ports 21 to 23 is associated and a VLAN ID (virtual network identification information) for identifying a VLAN in association with a port number of each of the ports 21 to 23 to manage. Note that the domain/VLAN information control unit 18 notifies a domain number of a domain with which a port which becomes a transmission source is associated and a VLAN ID of the VLAN in response to a request from the loop detection control unit 14 at a time of generation of a loop detection frame as described later.

The information which the domain/VLAN information control unit 18 described above manages may be managed together by the port information control unit 17 described above. Note that, although FIG. 3 illustrates a case that the network device 1 includes three ports 21 to 23, a number of ports included in the network device 1 is not limited to three.

The transmission control unit 11 (a loop detection frame transmission means) described above transmits a loop detection frame generated by the loop detection control unit 14 from a port which becomes a transmission source to other device on a network at a period specified by the loop detection control unit 14. In the following, generation of a loop detection frame by the loop detection control unit 14 will be described.

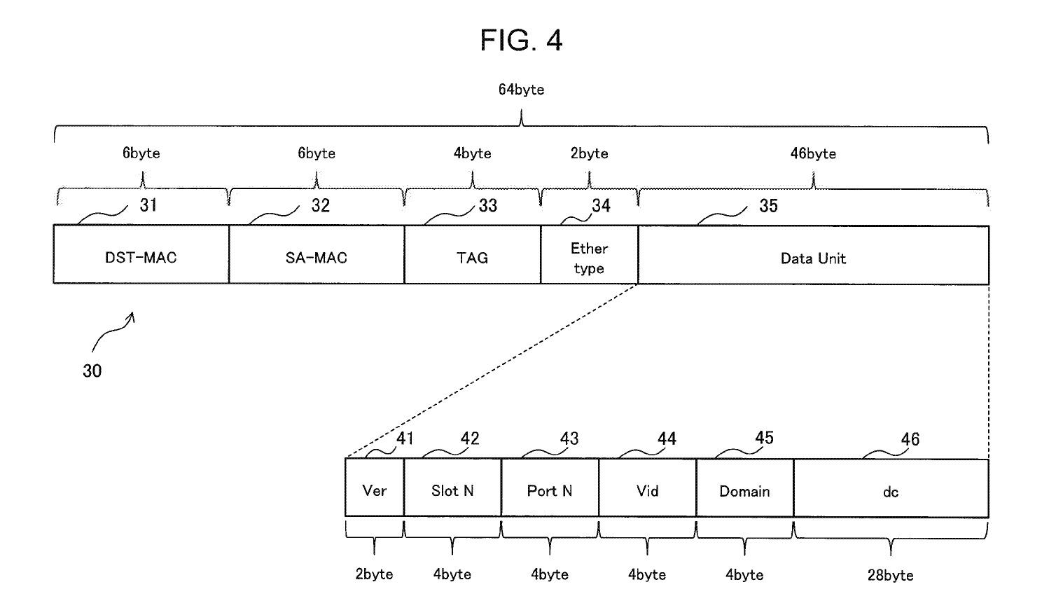

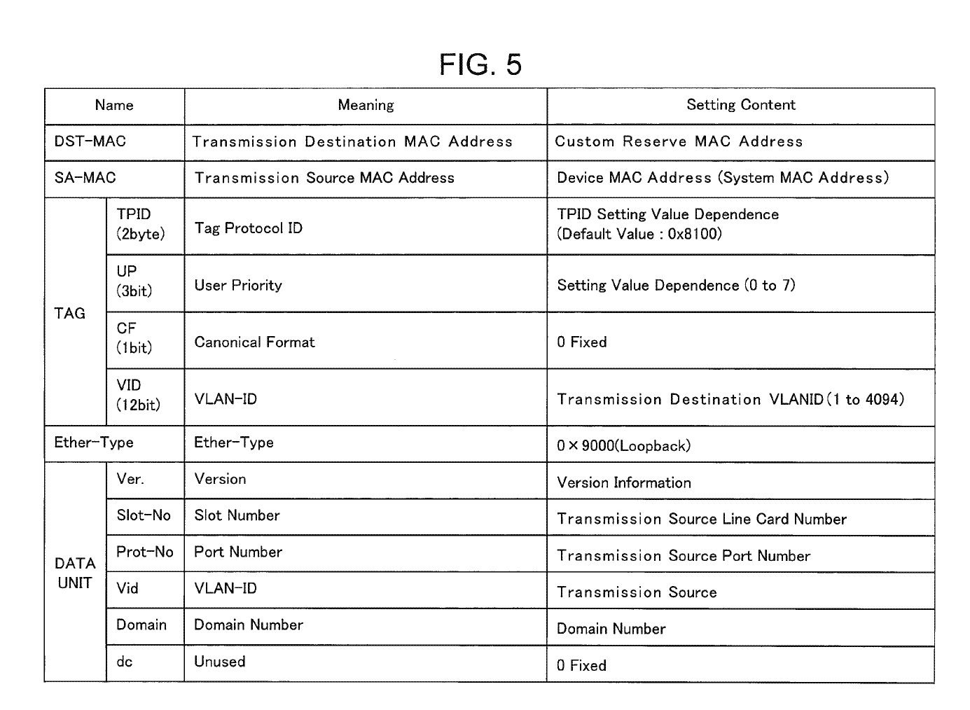

The loop detection control unit 14 (a loop detection means) generates a loop detection frame 30 which is transmitted from a domain specified by a user. An example of a data structure of the loop detection frame 30 is illustrated in FIG. 4 and FIG. 5.

In particular, the loop detection control unit 14 first obtains port information such as a port number of a port which becomes a transmission source of a loop detection frame from the port information control unit 17 at a time of generation of the loop detection frame 30. In addition, the loop detection control unit 14 obtains from the domain/VLAN information control unit 18 domain information of a domain and VLAN information of the VLAN with which the port of the transmission source is associated. Then, the loop detection control unit 14 stores each piece of information and the like described above in Slot-No 42, Port-No 43, Vid 44, and Domain 45 which constitute a Data unit 35 of the loop detection frame 30. In addition to this, the loop detection control unit 14 stores a MAC address (transmission source device identification information) for identifying the local device which becomes the transmission source of the loop detection frame 30 in SA-MAC 32 of the loop detection frame 30.

Thereby, in the loop detection frame 30, a MAC address for identifying a network device of a transmission source of the loop detection frame 30, and domain identification information and VLAN identification information which respectively identify a domain and a VLAN with which the port of the transmission source are associated are to be included. Note that the loop detection frame 30 does not necessarily include all information described above but it is sufficient if at least information to identify a device of the transmission source of the loop detection frame 30 and information to identify a domain with which the port of the transmission source is associated are included.

The loop detection control unit 14 notifies a transmission period specified by a user together with the generated loop detection frame 30 to the transmission control unit 11. Thereby, the transmission control unit 11 transmits the loop detection frame 30 from the specified port at the specified transmission period as described above. At this time, the transmission control unit 11 transmits the loop detection frame 30 to a port of other device on the network associated with the same domain as a domain with which a port which becomes a transmission source of the loop detection frame 30 is associated.

Having received a loop detection frame transmitted from other device via each of the ports 21 to 23, the receiving control unit 12 (a loop detection frame receiving means, a loop detection means) described above first determines whether it is a loop detection frame transmitted from the local device or a loop detection frame transmitted from other device. In particular, the receiving control unit 12 checks whether or not SA-MAC 32 of the received loop detection frame 30 is the MAC address of the local device.

Then, when the received loop detection frame is determined to be the loop detection frame transmitted by the local device, the receiving control unit 12 notifies the received loop detection frame 30 to the loop detection control unit 14. At the same time, the receiving control unit 12 obtains information such as a port number of the port via which the loop detection frame 30 has been received from the port information control unit 17 to notify to the loop detection control unit 14.

In response to this, the loop detection unit 14 extracts a VLAN ID of Vid 44 and a domain number of Domain 45 from the received loop detection frame 30. In other words, the VLAN ID of the VLAN with which the transmission source port of the received loop detection frame is associated and a domain number of a domain with which the transmission source port is associated are obtained. Furthermore, based on the port number of the port via which the loop detection frame 30 has been received, the loop detection control unit 14 obtains from the domain/VLAN information control unit 18 the VLAN ID of the VLAN and a domain number of the domain with which the received port is associated. Note that the VLAN ID and the domain number of the port via which the loop detection frame 30 has been received may be obtained from the port information control unit 17.

The loop detection unit 14 then examines whether or not the VLAN ID and the domain number extracted from the loop detection frame 30, and the VLAN ID and the domain number of the port via which the frame 30 has been received coincide. At this time, the loop detection unit 14 determines as a loop occurrence within the same network regardless of whether or not the VLAN-IDs coincide when the domain numbers coincide. The loop detection unit 14 then performs a notification of the port number for specifying the port via which the loop detection frame 30 has been received and a loop occurrence notification to the MIB trap control unit 16. In addition to this, the loop detection unit 14 determines according to a user setting whether to perform blockage of the port which has received the loop occurrence notification and performs port blockage according to the setting. When the port blockage is performed, the loop detection unit 14 performs a blockage notification to the MIB trap control unit 16.

Furthermore, when the domain number of the domain with which the transmission source port of the received loop detection frame 30 is associated is different from the domain number of the domain with which the port via which the frame has been received is associated, the loop detection unit 14 determines that the loop detection frame 30 is transmitted in a different network and does not determine as a loop occurrence. At this time, it is not determined as a loop occurrence even when the VLAN ID of the VLAN with which the transmission source port of the received loop detection frame 30 is associated and the VLAN ID of the VLAN with which the port via which the frame has been received is associated are the same. In this case, in other words, when the domain numbers are different but the VLAN IDs are the same, the loop detection unit 14 discards the received loop detection frame 30 and does not perform notification to the MIB trap control unit 16. Alternatively, the loop detection unit 14 performs a frame transfer to a port of the same domain as the domain with which the port via which the loop detection frame 30 has been received is associated through the transfer control unit 13. Note that a selection of which operation to be performed is possible by a user setting in advance.

Note that, when it is determined that the received loop detection frame 30 is a loop detection frame transmitted from other device, the receiving control unit 12 notifies the transfer control unit 13 of the loop detection frame. Then, the transfer control unit 13 (a transmission means) transfers the loop detection frame 30 from each port provided and associated with the same domain as the domain with which the transmission source port of the received loop detection frame 30 is associated to a port provided on other device associated with the same domain.

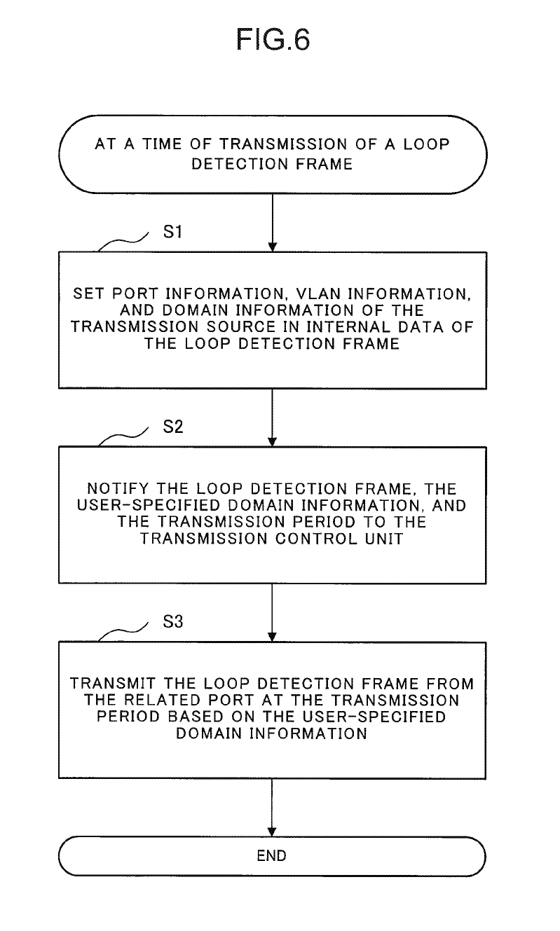

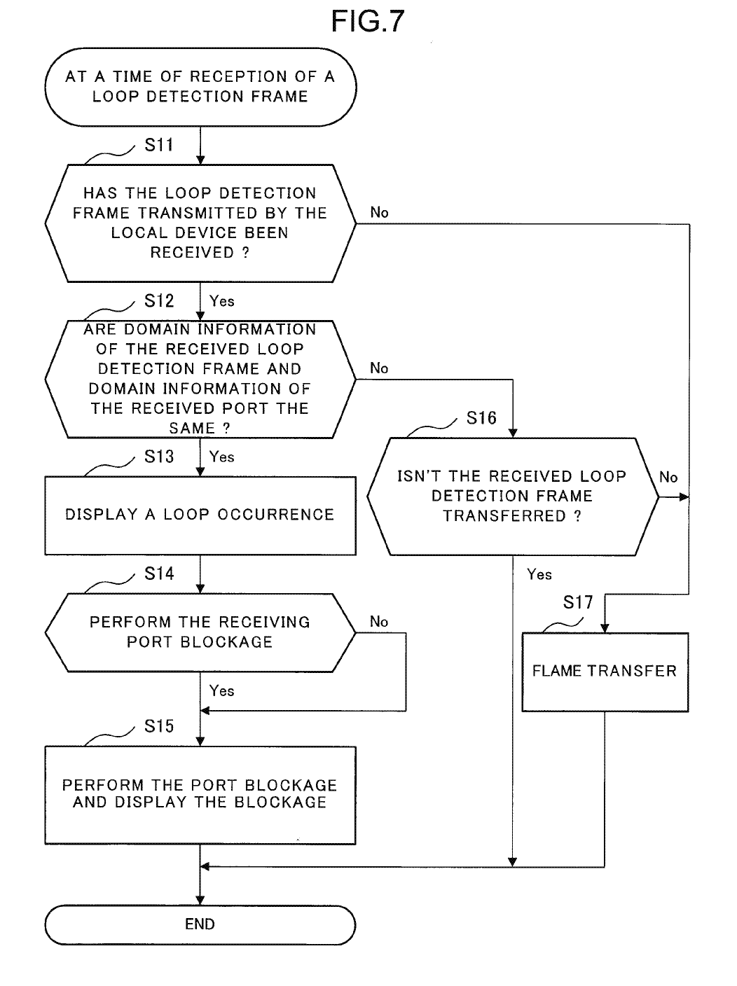

In the following, operation of the network device 1 of the configuration described above will be described with reference to flowcharts of FIG. 6 to FIG. 7. Referring to FIG. 6, operation when the loop detection frame is transmitted will be described and, referring to FIG. 7, operation when the loop detection frame has been received will be described.

First, in the network device 1, the loop detection control unit 14 for controlling loop detection is activated by an instruction of the command control unit 15 for controlling a command input from a user.

Next, transmission operation of a loop detection frame will be described. The loop detection control unit 14 generates the loop detection frame 30 which is transmitted from a domain specified by a user (step S1 of FIG. 6). In particular, the loop detection control unit 14 first obtains from the port information control unit 17 port information such as a port number of a port which becomes a transmission source of the loop detection frame. Furthermore, the loop detection control unit 14 obtains from the domain/VLAN information control unit 18 domain information of a domain and VLAN information of a VLAN with which the port of the transmission source is associated. The loop detection control unit 14 then stores each piece of information in Slot-No 42, Port-No 43, Vid 44, and Domain 45 which constitute the Data unit 35 of the loop detection frame 30. In addition to this, the loop detection control unit 14 stores a MAC address for identifying the local device which becomes a transmission source of the loop detection frame 30 in SA-MAC 32 of the loop detection frame 30.

The loop detection control unit 14 then notifies the transmission control unit 11 of the generated loop detection frame 30 and a transmission period specified by the user (step S2 of FIG. 6). The transmission control unit 11 transmits the loop detection frame 30 from the specified port at the specified period (step S3 of FIG. 6).

In the following, receiving operation of the loop detection frame will be described. First, when the loop detection frame 30 is received via each of the ports 21 to 23 of the network device 1, each port transmits the received loop detection frame 30 to the receiving control unit 12. The receiving control unit 12 first determines whether the received loop detection frame is a loop detection frame transmitted by the local device or a loop detection frame transmitted by other device (step S11 of FIG. 7). In particular, the receiving control unit 12 examines whether or not the SA-MAC 32 of the received loop detection frame 30 is the MAC address of the local device.

When having determined that the received loop detection frame is the one transmitted by the local device (Yes in step S11 of FIG. 7), the receiving control unit 12 notifies the loop detection control unit 14 of the received loop detection frame 30. In addition to this, the receiving control unit 12 obtains from the port information control unit 17 information such as a port number of the port via which the loop detection frame 30 has been received to notify the loop detection control unit 14 of the information.

Subsequently, the loop detection unit 14 extracts a VLAN ID of the Vid 44 and a domain number of the Domain 45 from the received loop detection frame 30. Furthermore, based on the port number of the port via which the loop detection frame 30 has been received, the loop detection control unit 14 obtains from the domain/VLAN information control unit 18 the VLAN ID of the VLAN and the domain number of the domain with which the port is associated.

The loop detection control unit 14 examines whether or not the VLAN ID and the domain number extracted from the loop detection frame 30 and the VLAN ID and the domain number of the port via which the frame 30 has been received coincide. At this time, the loop detection unit 14 determines as a loop occurrence within the same network (step S13 of FIG. 7) when the domain numbers coincide (Yes in step S12 of FIG. 7) regardless of whether or not the VLAN-IDs coincide. The loop detection unit 14 then performs a notification of the port number for specifying the port via which the loop detection frame 30 has been received and a loop occurrence notification to the MIB trap control unit 16. In addition to this, the loop detection unit 14 determines according to a user setting whether to perform blockage of the port which has received the loop occurrence notification and performs port blockage according to the setting (Yes in step S14 of FIG. 7, step S15). When the port blockage is performed, the loop detection unit 14 performs a blockage notification to the MIB trap control unit 16.

Furthermore, when the domain number of the domain with which the transmission source port of the received loop detection frame 30 is associated is different from the domain number of the domain with which the port via which the frame has been received is associated, the loop detection unit 14 determines that the loop detection frame 30 is transmitted in a different network and does not determine as a loop occurrence (No in step S12 of FIG. 7). At this time, it is not determined as a loop occurrence even when the VLAN ID of the VLAN with which the transmission source port of the received loop detection frame 30 is associated and the VLAN ID of the VLAN with which the port via which the frame has been received is associated are the same. In this case, the loop detection unit 14 discards the received loop detection frame 30 without transferring the frame (Yes in step S16 of FIG. 7). Note that, at this time, the loop detection unit 14 may perform a frame transfer process to a port of the same domain as the domain with which the port via which the loop detection frame 30 has been received is associated (No in step S16 of FIG. 7, step S17).

Note that, when having determined that the received loop detection frame 30 is a loop detection frame transmitted from other device (No in step S11 of FIG. 7), the receiving control unit 12 transfers the loop detection frame 30 from each provided port associated with the same domain as the domain with which the transmission source port of the loop detection frame 30 via which the frame has been received is associated to a port provided on other device associated with the same domain (step S17 of FIG. 7).

As described above, the network device 1 of the present invention transmits a loop detection frame from the local device on a domain unit basis and performs determination of domain attributes of a port of a transmission source of the loop detection frame transmitted by the local device and a port via which the frame has been received. When attributes of the port of the transmission source of the received loop detection frame and the port via which the frame has been received are the same domain, it is determined that the frame loops in the same network even if VLAN IDs thereof are different, which makes loop detection possible. On the other hand, when the attributes of the port of the transmission source of the loop detection frame and the port via which the frame has been received are different domains even if VLAN IDs thereof are the same, it is determined that the frame is transmitted from a different network, which makes it possible not to determine as a loop.

Thereby, the network device of the present invention can properly detect a loop in a network of domain units. Particularly, loop detection can be performed regardless of whether virtual networks with which a port which becomes a transmission source of a loop detection frame and a port via which the frame has been received are associated are the same or different.

### Exemplary Embodiment 2

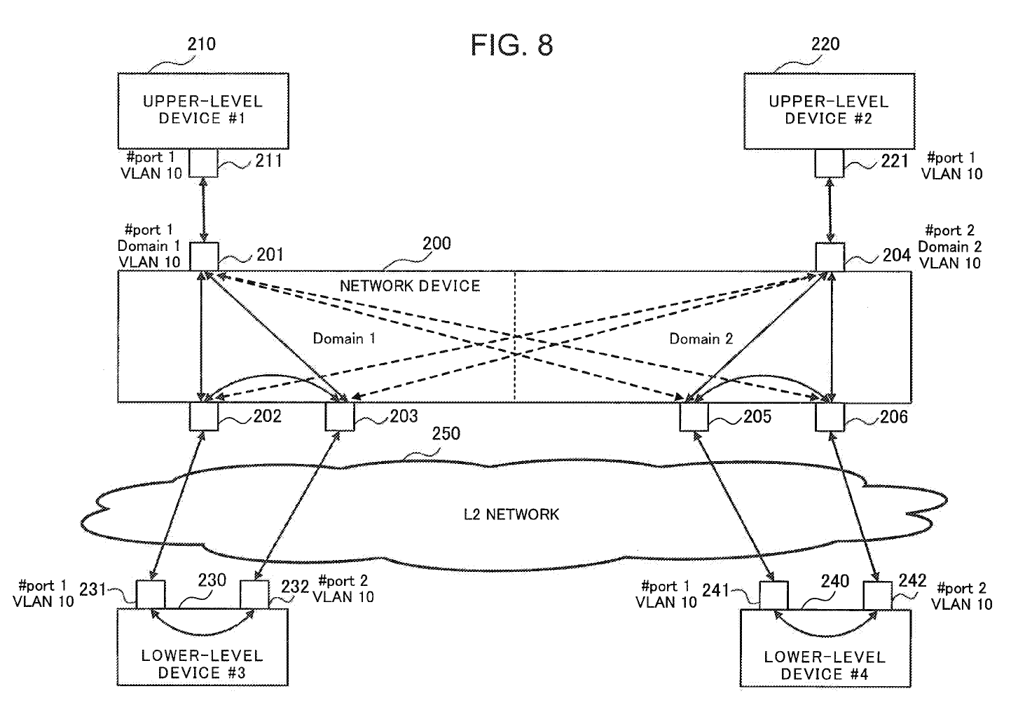

Next, a second exemplary embodiment of the present invention will be described with reference to FIG. 8. FIG. 8 is a diagram illustrating a configuration of a network system and a flow of a loop detection frame of the present invention.

As illustrated in FIG. 8, the network system includes an upper-level device #1 (210) and an upper-level device #2 (220) (first network devices) which are the network devices described above and a network device 200 (a second network device) which is connected to the upper-level devices #1 and #2. In addition, the network system further includes a lower-level device #3 (230) and a lower-level device #4 (240) which are connected to the network device via an L2 network 250.

A port 211 of the upper-level device #1 (210) is associated with a Domain 1 domain and a port 221 of the upper-level device #2 (220) is associated with a Domain 2 domain. Furthermore, ports 201, 202, and 203 of the network device are associated with the Domain 1 domain, and ports 204, 205 and 206 are associated with the Domain 2 domain. In addition, ports 231 and 232 of the lower-level device #3 (230) are associated with the Domain 1 domain, and ports 241 and 242 of the lower-level device #4 (240) are associated with the Domain 2 domain. Note that all ports described above are associated with the same VLAN (VLAN ID=10).

In a situation described above, it is assumed that the upper-level device #1 (210) and the upper-level device #2 (220) which are associated with different domains have transmitted loop detection frames to each domain. Then, the network device 200 receives the loop detection frame via the port 201 associated with the Domain 1 domain and performs a frame transfer to the ports 202 and 203 associated with the same domain (Domain 1) as the port 201 via which the frame has been received within the network device 200 (refer to solid arrows of FIG. 8). In other words, the network device 200 does not perform a frame transfer to the ports 205 and 206 associated with a domain (Domain 2) different from the port 201 which has received (refer to dotted arrows of FIG. 8). The same is true when a loop detection frame has been received via the port 204 of the network device 200.

Subsequently, the network device 200 transfers the loop detection frame to the L2 network 250 via each port within the same domain as the port via which the loop detection frame has been received. In particular, the ports 202 and 203 associated with Domain 1 of the network device 200 transfer the loop detection frame to the lower-level device #3 (230) via the L2 network 250 and the ports 205 and 206 associated with Domain 2 of the network device 200 transfer the loop detection frame to the lower-level device #4 (240) via the L2 network 250.

In this case, when there is an erroneous connection in the L2 network 250, the loop detection frame is transferred to a port associated with the same VLAN as the VLAN with which the transmission source port of the frame is associated, with respect to the lower-level device #3 (230) and the lower-level device #4 (240). Although this is a normal operation, the loop detection frame is transferred to the respective ports (231 and 232, 241 and 242) provided to the lower-level device #3 (230) and the lower-level device #4 (240) because of the erroneous connection in the L2 network 250. Then the loop detection frame is transferred to the upper-level device #1 (210) and the upper-level device #2 (220). Thereby, it becomes possible that the upper-level device #1 (210) and the upper-level device #2 (220) detect a loop occurrence.

As described above, a loop can be properly detected in a network of domain units by adopting the configuration of the network system according to the present exemplary embodiments. Particularly, loop detection can be performed regardless of whether virtual networks with which a port which becomes a transmission source of a loop detection frame and a port via which the frame has been received are associated are the same or different.

(Supplementary Notes)

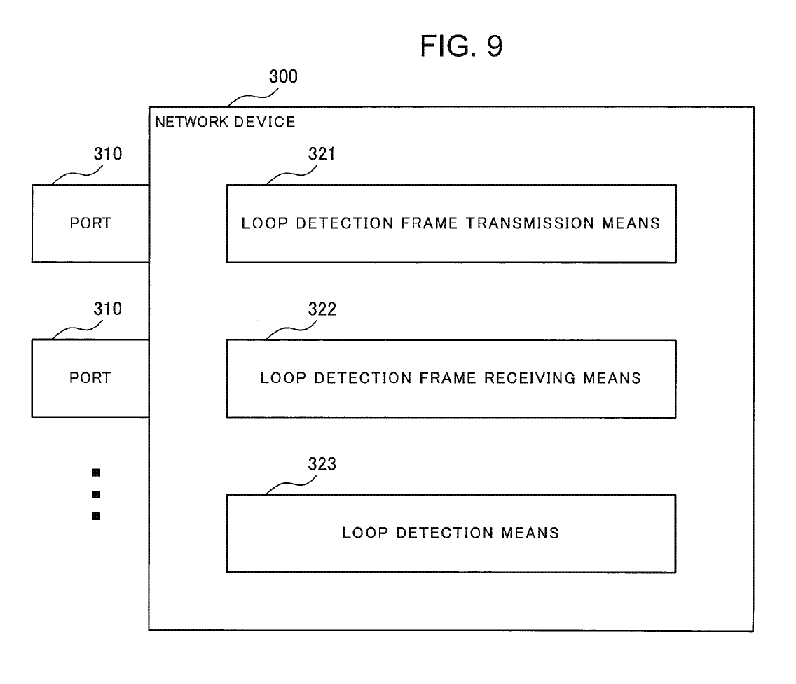

Some or all of the exemplary embodiments described above may also be described as in the following supplementary notes. Hereinafter, schematic configurations of a network device (refer to FIG. 9), a network system, a program, and a loop detection method according to the present invention will be described. However, the present invention is not limited to the following configurations.

(Supplementary Note 1)

A network device 300 including a plurality of ports 310 each associated with a preset virtual network and a domain which constitutes a network of group units different from the virtual network

and further including:

loop detection frame transmission means 321 for transmitting a loop detection frame to other device on a network from the ports;

loop detection frame receiving means 322 for receiving the loop detection frame from other device on a network via the ports; and

loop detection means 323 for detecting a loop occurrence when, based on the loop detection frame received by the loop detection frame receiving means, a transmission source of the loop detection frame is the local device and a port via which the loop detection frame has been received and a port of the transmission source of the loop detection frame are associated with the same domain.

(Supplementary Note 2)

The network device according to the supplementary note 1, wherein

the loop detection means

generates the loop detection frame including transmission source device identification information for identifying the local device which becomes a transmission source of the loop detection frame and domain identification information for identifying the domain with which the port which becomes a transmission source of the loop detection frame is associated when the loop detection frame is transmitted by the loop detection frame transmission means and

detects a loop occurrence when the transmission source of the loop detection frame is the local device and the domain with which the port via which the loop detection frame has been received is associated and the domain with which the port of the transmission source of the loop detection frame is associated are the same, based on the transmission source device identification information and the domain identification information included in the loop detection frame, when the loop detection frame has been received by the loop detection frame receiving means.

(Supplementary Note 3)

The network device according to the supplementary note 2, wherein

the loop detection means

generates the loop detection frame including virtual network identification information for identifying the virtual network with which the port which becomes the transmission source of the loop detection frame is associated when the loop detection frame is transmitted by the loop detection frame transmission means and

detects a loop occurrence when the transmission source of the loop detection frame is the local device and the domain with which the port via which the loop detection frame has been received is associated and the domain with which the port of the transmission source of the loop detection frame is associated are the same, even when the virtual network with which the port via which the loop detection frame has been received is associated and the virtual network with which the port of the transmission source of the loop detection frame is associated are different, based on the virtual network identification information included in the loop detection frame, when the loop detection frame has been received by the loop detection frame receiving means.

(Supplementary Note 4)

The network device according to the supplementary note 3, wherein

the loop detection means discards the received loop detection frame when the loop occurrence is not detected and when the virtual network with which the port via which the loop detection frame has been received is associated and the virtual network with which the port of the transmission source of the loop detection frame is associated are the same.

(Supplementary Note 5)

The network device according to any one of the supplementary notes 1 to 4, wherein,

when the loop detection means has determined that the transmission source of the loop detection frame received by the loop detection frame receiving means is not the local device, the loop detection frame transmission means transfers the loop detection frame, based on the received loop detection frame, to a port which is a port provided on other device in a network, the port being associated with the same domain as the domain with which the port which becomes a transmission source of the loop detection frame is associated, from a port provided on the local device associated with the same domain.

(Supplementary Note 6)

A network system including a plurality of network devices, each of which includes

a plurality of ports each associated with a preset virtual network and a domain which constitutes a network of group units different from the virtual network

and further includes:

loop detection frame transmission means for transmitting a loop detection frame to other device on a network from the ports;

loop detection frame receiving means for receiving the loop detection frame from other device on a network via the ports; and

loop detection means for detecting a loop occurrence when, based on the loop detection frame received by the loop detection frame receiving means, a transmission source of the loop detection frame is the local device and a port via which the loop detection frame has been received and a port of the transmission source of the loop detection frame are associated with the same domain,

wherein, the plurality of network devices include: a first network device for transmitting the loop detection frame to other network device; and a second network device for receiving the loop detection frame,

in the second network device, when the loop detection means has determined that the transmission source of the loop detection frame received by the loop detection frame receiving means is not the local device, the loop detection frame transmission means transfers the loop detection frame, based on the received loop detection frame, to a port which is a port provided on other device in a network, the port being associated with the same domain as the domain with which the port which becomes a transmission source of the loop detection frame is associated, from a port provided on the local device associated with the same domain.

(Supplementary Note 7)

A program for causing a network device including a plurality of ports each associated with a preset virtual network and a domain which constitutes a network of group units different from the virtual network to realize:

loop detection frame transmission means for transmitting a loop detection frame to other device on a network from the ports;

loop detection frame receiving means for receiving the loop detection frame from other device on a network via the ports; and

loop detection means for detecting a loop occurrence when, based on the loop detection frame received by the loop detection frame receiving means, a transmission source of the loop detection frame is the local device and a port via which the loop detection frame has been received and a port of the transmission source of the loop detection frame are associated with the same domain.

(Supplementary Note 8)

The program according to the supplementary note 7, wherein

the loop detection means

generates the loop detection frame including transmission source device identification information for identifying the local device which becomes a transmission source of the loop detection frame and domain identification information for identifying the domain with which the port which becomes a transmission source of the loop detection frame is associated when the loop detection frame is transmitted by the loop detection frame transmission means and

detects a loop occurrence when the transmission source of the loop detection frame is the local device and the domain with which the port via which the loop detection frame has been received is associated and the domain with which the port of the transmission source of the loop detection frame is associated are the same, based on the transmission source device identification information and the domain identification information included in the loop detection frame, when the loop detection frame has been received by the loop detection frame receiving means.

(Supplementary Note 9)

A loop detection method for a network device including a plurality of ports each associated with a preset virtual network and a domain which constitutes a network of group units different from the virtual network, including:

transmitting a loop detection frame to other device on a network from the ports;

receiving the loop detection frame from other device on a network via the ports; and

detecting a loop occurrence when, based on the received loop detection frame, a transmission source of the loop detection frame is the local device and a port via which the loop detection frame has been received and a port of the transmission source of the loop detection frame are associated with the same domain.

(Supplementary Note 10)

The loop detection method according to the supplementary note 9, comprising:

generating the loop detection frame including transmission source device identification information for identifying the local device which becomes a transmission source of the loop detection frame and domain identification information for identifying the domain with which the port which becomes a transmission source of the loop detection frame is associated when the loop detection frame is transmitted; and

detecting a loop occurrence when the transmission source of the loop detection frame is the local device and the domain with which the port via which the loop detection frame has been received is associated and the domain with which the port of the transmission source of the loop detection frame is associated are the same, based on the transmission source device identification information and the domain identification information included in the loop detection frame, when the loop detection frame has been received.

Note that the program described above is stored in a storage device or recorded in a computer-readable recording medium. For example, the storage medium is a portable medium such as a flexible disk, an optical disk, a magneto-optical disk, and a semiconductor memory.

Having thus described the present invention with reference to the exemplary embodiments and the like described above, the present invention is not limited to the exemplary embodiments described above. It is possible to make various modifications, which can be understood by those skilled in the art, to configurations and details of the present invention within the scope of the present invention.

It should be noted that the present invention is indented to enjoy benefits of the priority claim based on Patent Application No. 2012-282426, filed Dec. 26, 2012 in Japan and entire contents described in the patent application are included herein.

### REFERENCE SIGNS LIST

1 Network device

11 Transmission control unit

12 Receiving control unit

13 Transfer control unit

14 Loop detection control unit

15 Command control unit

16 MIB trap control nit

17 Port information control unit

18 Domain/VLAN information control unit

21, 22, 23 Port

30 Loop detection frame

100 Network device

101 to 107 Port

110 Other device

120 L2 network

200 Network device

210, 220 Upper-level device

230, 240 Lower-level device

250 L2 network

300 Network device

310 Port

321 Loop detection frame transmission means

322 Loop detection frame receiving means

323 Loop detection means

1. A network device comprising a plurality of ports each associated with a preset virtual network and a domain which constitutes a network of group units different from the virtual network
and further comprising:
a loop detection frame transmission unit that transmits a loop detection frame to other device on a network from the ports;
a loop detection frame receiving unit that receives the loop detection frame from other device on a network via the ports; and
a loop detection unit that detects a loop occurrence when, based on the loop detection frame received by the loop detection frame receiving unit, a transmission source of the loop detection frame is the local device and a port via which the loop detection frame has been received and a port of the transmission source of the loop detection frame are associated with the same domain.

2. The network device according to claim 1, wherein
the loop detection unit
generates the loop detection frame including transmission source device identification information for identifying the local device which becomes a transmission source of the loop detection frame and domain identification information for identifying the domain with which the port which becomes a transmission source of the loop detection frame is associated when the loop detection frame is transmitted by the loop detection frame transmission unit, and
detects a loop occurrence when the transmission source of the loop detection frame is the local device and the domain with which the port via which the loop detection frame has been received is associated and the domain with which the port of the transmission source of the loop detection frame is associated are the same, based on the transmission source device identification information and the domain identification information included in the loop detection frame, when the loop detection frame has been received by the loop detection frame receiving unit.

3. The network device according to claim 2, wherein
the loop detection unit
generates the loop detection frame including virtual network identification information for identifying the virtual network with which the port which becomes the transmission source of the loop detection frame is associated when the loop detection frame is transmitted by the loop detection frame transmission means unit, and
detects a loop occurrence when the transmission source of the loop detection frame is the local device and the domain with which the port via which the loop detection frame has been received is associated and the domain with which the port of the transmission source of the loop detection frame is associated are the same, even when the virtual network with which the port via which the loop detection frame has been received is associated and the virtual network with which the port of the transmission source of the loop detection frame is associated are different, based on the virtual network identification information included in the loop detection frame, when the loop detection frame has been received by the loop detection frame receiving unit.

4. The network device according to claim 3, wherein
the loop detection unit discards the received loop detection frame when the loop occurrence is not detected and when the virtual network with which the port via which the loop detection frame has been received is associated and the virtual network with which the port of the transmission source of the loop detection frame is associated are the same.

5. The network device according to claim 1, wherein,
when the loop detection unit has determined that the transmission source of the loop detection frame received by the loop detection frame receiving unit is not the local device, the loop detection frame transmission unit transfers the loop detection frame, based on the received loop detection frame, to a port which is a port provided on other device in a network, the port being associated with the same domain as the domain with which the port which becomes a transmission source of the loop detection frame is associated, from a port provided on the local device associated with the same domain.

6.-8. (canceled)

9. A loop detection method performed by a network device comprising a plurality of ports each associated with a preset virtual network and a domain which constitutes a network of group units different from the virtual network, the method comprising:
transmitting a loop detection frame to other device on a network from the ports,
receiving the loop detection frame from other device on a network via the ports, and
detecting a loop occurrence when, based on the received loop detection frame, a transmission source of the loop detection frame is the local device and a port via which the loop detection frame has been received and a port of the transmission source of the loop detection frame are associated with the same domain.

10. The loop detection method according to claim 9, wherein
the loop detection frame including transmission source device identification information for identifying the local device which becomes a transmission source of the loop detection frame and domain identification information for identifying the domain with which the port which becomes a transmission source of the loop detection frame is associated is generated when the loop detection frame is transmitted and
a loop occurrence is detected when the transmission source of the loop detection frame is the local device and the domain with which the port via which the loop detection frame has been received is associated and the domain with which the port of the transmission source of the loop detection frame is associated are the same, based on the transmission source device identification information and the domain identification information included in the loop detection frame, when the loop detection frame has been received.

11. A network device comprising a plurality of ports each associated with a preset virtual network and a domain which constitutes a network of group units different from the virtual network
and further comprising:
loop detection frame transmission means for transmitting a loop detection frame to other device on a network from the ports;
loop detection frame receiving means for receiving the loop detection frame from other device on a network via the ports; and
loop detection means for detecting a loop occurrence when, based on the loop detection frame received by the loop detection frame receiving means, a transmission source of the loop detection frame is the local device and a port via which the loop detection frame has been received and a port of the transmission source of the loop detection frame are associated with the same domain.
